(19) United States
(12) Patent Application Publication
(10) Pub. No.: US 2012/0173412 A1
(43) Pub. Date: Jul. 5, 2012

(54) Rights Clearance for Granular Rights

(75) Inventors: David E. Rosenstein, San Francisco, CA (US); David G. King, Mountain View, CA (US); Kevin G. Montler, Pleasanton, CA (US)

(73) Assignee: GOOGLE INC., Mountain View, CA (US)

(21) Appl. No.: 13/314,998

(22) Filed: Dec. 8, 2011

Related U.S. Application Data
(60) Provisional application No. 61/430,153, filed on Jan. 5, 2011.

(51) Int. Cl. G06Q 50/00; G06Q 40/00

(52) U.S. Cl. 705/39; 705/310

(57) ABSTRACT

A system and method for clearing granular rights is disclosed. The system comprises communication module, a territorial requirements engine, an existing license module and a determination module. The communication module for receives, from a service provider, a description of a service to be provided for an asset in a territory. The territorial requirements engine determines a territorial requirement for providing the service in the territory based at least in part on a territorial rule for the territory. The existing license module determines a missing right based at least in part on the territorial requirement. The determination module determines a preferred licensor for purchasing a license for the missing right in the territory.

### CROSS-REFERENCE

This application claims priority from the following U.S. provisional patent application, which is hereby incorporated by reference: Ser. No. 61/430,153, filed on Jan. 5, 2011 entitled “GRANULAR RIGHTS MANAGEMENT SYSTEM”.

### BACKGROUND

The specification relates to data management systems. In particular, the specification relates to a system and method for clearing granular rights.

Owners of intellectual property assets (e.g., a video, a book, a song, a video game, etc.) desire to monetize these assets. As the online commerce is increasing, more and more owners wish to monetize these assets using online services. For example, one approach to monetize a song is to provide an online service that sells a copy of a song to a user by downloading a copy of the song to a computer operated by the user. This is an example of a service that sells the song by synching the song to a computer. There are numerous other services that can be provided by the service provider. For example, the song can be streamed online for playback by the user, the song can be downloaded to the user's computer and configured to become unplayable after an occurrence of one or more events, etc. Persons having skill in the art will recognize that other types of services are possible, and that similar or different services can be provided for the other types of intellectual property assets (e.g., a video, a book, a video game, etc.).

Ownership of these assets is defined by the copyright laws of different jurisdictions (i.e., territories). The copyright law of a territory defines different rights that can be owned for an asset. For example, the copyright law of the United States (or any other jurisdiction) defines the rights for a song includes a public performance right, a reproduction right, a distribution right, a synchronization (“sync”) right and a right to make a derivative work. These rights can be referred to collectively or individually as “granular rights.” Rights for an asset are jurisdiction specific. For example, the rights defined by the copyright law of Brazil (or any other country) may be different than those defined under the law of the United States.

Persons having skill in the art will also recognize that sometimes more than one entity can own rights in an asset. For example, a recording contract might give ownership of the sync right for a song in Brazil to a first entity, while a second entity owns the sync right in the United States. Also, more than one person can own a portion of a right in any given territory. For example, a first entity can own 80% of the sync right for the song in the United States, while, at the same time, a second entity owns 20% of the sync right for the same song in the United States.

To monetize an intellectual property asset, the service provider is required to obtain licenses that enable the service provider to legally provide the service in a particular jurisdiction. For example, assume a service provider wants to provide a particular service in the United States. Since the service is being provided in the United States, this service is governed under the laws of the United States. The laws of this territory will define a set of rights (i.e., a bundle of rights) that must be licensed by the service provider in order to legally provide the service. Further assume that for this particular service the copyright laws of the United States require the service provider to have licensed the sync right and the distribution right from the owner of these rights in United States. Accordingly, if the service provider wants to legally provide this service in the United States, the service provider must determine who owns the sync right and the distribution right for the song in the United States and then negotiate a licensing agreement with these owners. This presents numerous problems.

First, the service provider must track the different laws of the different territories in which they want to do business, and keep track of what rights are required in these different territories in order to provide the different services they want to provide.

Second, the service provider must track their existing licensing agreements in order to know what rights they currently have licensed and what further rights they need to acquire in order to legally provide a particular service in a particular jurisdiction.

Third, since different entities own different rights for different territories and the laws of different countries specify that certain rights must be acquired from a particular entity specified by the law (e.g., a publishing rights administrator), the service provider must keep track of which entities can provide which licenses.

Fourth, since laws change over time, the service provider must track changes to the laws of the different countries.

### SUMMARY OF THE INVENTION

The specification overcomes the deficiencies and limitations of the prior art at least in part by providing a system and method for clearing granular rights. A system and method for clearing granular rights is disclosed. The system comprises communication module, a territorial requirements engine, an existing license module and a determination module. The communication module for receives, from a service provider, a description of a service to be provided for an asset in a territory. The territorial requirements engine determines a territorial requirement for providing the service in the territory based at least in part on a territorial rule for the territory. The existing license module determines a missing right based at least in part on the territorial requirement. The determination module determines a preferred licensor for purchasing a license for the missing right in the territory.

In one embodiment, the system further comprises a payment module. The payment module determines a payment for purchasing the license from the preferred licensor and pays the preferred licensor based at least in part on the determined payment.

### BRIEF DESCRIPTION OF THE DRAWINGS

The specification is illustrated by way of example, and not by way of limitation in the figures of the accompanying drawings in which like reference numerals are used to refer to similar elements.

FIG. 1 is a high-level block diagram illustrating a system for providing rights clearance for granular rights according to one embodiment.

FIG. 2 is a block diagram illustrating a clearance module according to one embodiment.

FIG. 3 is a block diagram illustrating a rules database according to one embodiment.

FIGS. 4A and 4B are flow diagrams illustrating a method for providing rights clearance for granular rights according to one embodiment.

FIGS. 5A-5C are flow diagrams illustrating a method for providing rights clearance for granular rights according to another embodiment.

FIG. 6 is a flow diagram illustrating a method for updating territorial rules according to one embodiment.

### DETAILED DESCRIPTION OF THE PREFERRED EMBODIMENTS

A system and method for providing rights clearance for granular rights is described below. In the following description, for purposes of explanation, numerous specific details are set forth in order to provide a thorough understanding of the specification. It will be apparent, however, to one skilled in the art that the embodiments can be practiced without these specific details. In other instances, structures and devices are shown in block diagram form in order to avoid obscuring the specification. For example, the specification is described in one embodiment below with reference to user interfaces and particular hardware. However, the description applies to any type of computing device that can receive data and commands, and any peripheral devices providing services.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The specification also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

Some embodiments can take the form of an entirely hardware embodiment, an entirely software embodiment or an embodiment containing both hardware and software elements. A preferred embodiment is implemented in software, which includes but is not limited to firmware, resident software, microcode, etc.

Furthermore, some embodiments can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing and/or executing program code for providing rights clearance for granular rights will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the various embodiments as described herein.

### System Overview

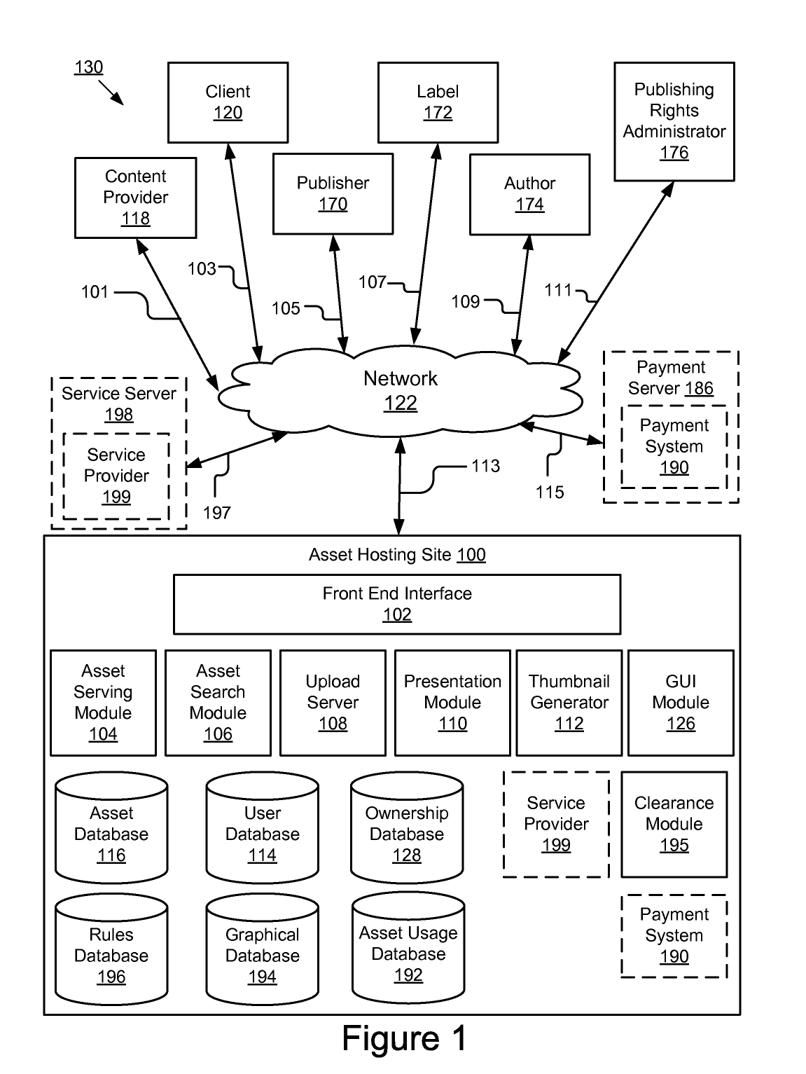

FIG. 1 is a high-level block diagram illustrating a system 130 for providing rights clearance according to one embodiment. The illustrated embodiment of the system 130 includes an asset hosting site 100, a content provider 118, a client 120, a publisher 170, a label 172, an author 174, a publishing rights administrator 176, a payment server 186 and a service server 198. These entities of the system 130 are communicatively coupled via a network 122. Although only one content provider 118, one client 120, one publisher 170, one label 172, one author 174, one publishing rights administrator 176, one payment server 186 and one service server 198 are illustrated, one skilled in the art will recognize that any number of content providers 118, clients 120, publishers 170, labels 172, authors 174, publishing rights administrators 176, payment servers 186 and service servers 198 can be communicatively coupled to the network 122. Furthermore, while only one network 122 is coupled to the client 120, the content provider 118, the publisher 170, the label 172, the author 174, the publishing rights administrator 176, the payment server 186 and the asset hosting site 100, one skilled in the art will appreciate that any number of networks 122 can be connected to these entities shown in FIG. 1.

In one embodiment, the asset hosting site 100 includes a service provider 199 and a clearance module 195. The service provider 199 is code and routines that, when executed by a processor of the asset hosting site 100 (not pictured), communicates with one or more of the components of the asset hosting site 100 to provide a service to a user such as the client 120. In one embodiment, the service provider 199 is communicatively coupled to the clearance module 195 to provide one or more inputs to the clearance module 195. For example, the service provider 199 provides one or more inputs to the clearance module 195 specifying an asset, a service to be provided for the asset and the territory in which the service will be provided. As will be described below, the clearance module 195 uses these inputs along with other data to clear granular rights for the asset so that the specified service can be provided in the specified territory.

The service provider 199 is depicted in FIG. 1 with a dashed line to indicate that in some embodiments the service provider 199 is stored on the asset hosting site 100, while in other embodiments the service provider 199 is stored on the service server 198. The service server 198 is a hardware server that includes one or more elements similar to the asset hosting site 100 necessary to enable the service server 198 to provide a service to a user such as the client 120. The service server 198 is depicted in FIG. 1 with a dashed line to indicate that it is an optional feature of the system 130. In embodiments where the system 130 does not include a service server 198, the service provider 199 is stored and executed by the asset hosting site 100. The service provider 199 is described in more detail below.

The clearance module 195 is code and routines that, when executed by the processor of the asset hosting site 100 (not pictured): (1) tracks the different laws of the different territories in which the service provider 199 provides services; (2) keeps track of what rights are required in these different territories in order to provide the different services provided by the service provider 199; (3) tracks the existing licenses owned by the service provider 199; and (4) determines, based on the (2) and (3) above, which further rights the service provider 199 needs to acquire in order to legally provide a particular service in a particular jurisdiction. For example, assume that the administrator of the service provider 199 wants to provide a service in which a song is streamed to users in a particular territory. The clearance module 195 determines that the laws of a territory require the service provider 199 to have a first, second and third license for the asset (i.e., the song). The clearance module 195 determines that the service provider 199 already owns the first and third license under one or more existing licensing agreements. The clearance module 195 determines, based on the above, that the service provider 199 must acquire the second license for the asset in order to provide service.

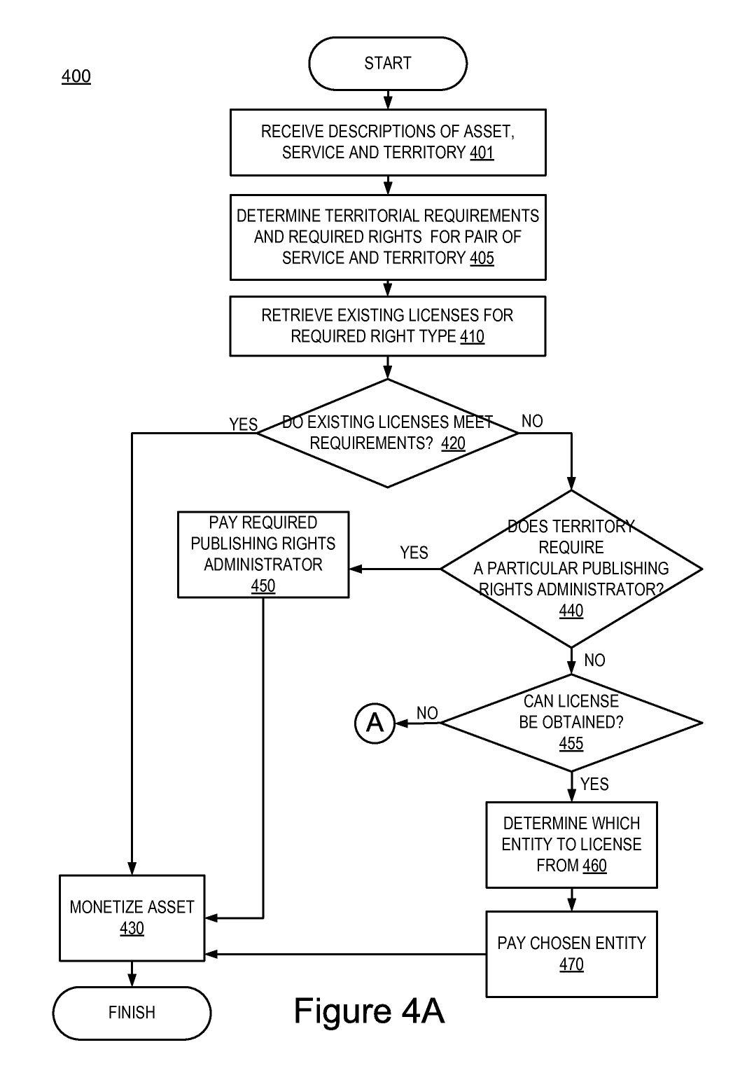

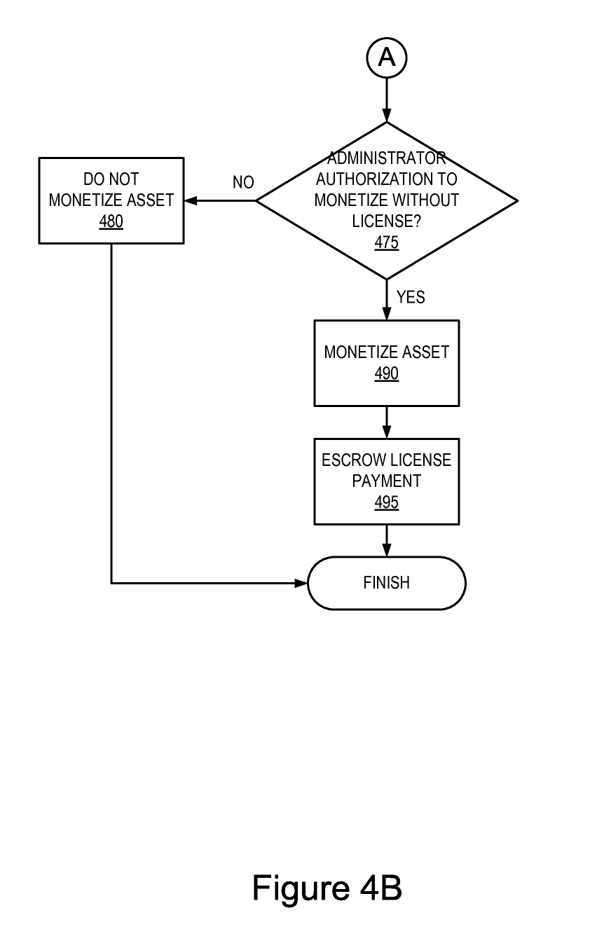

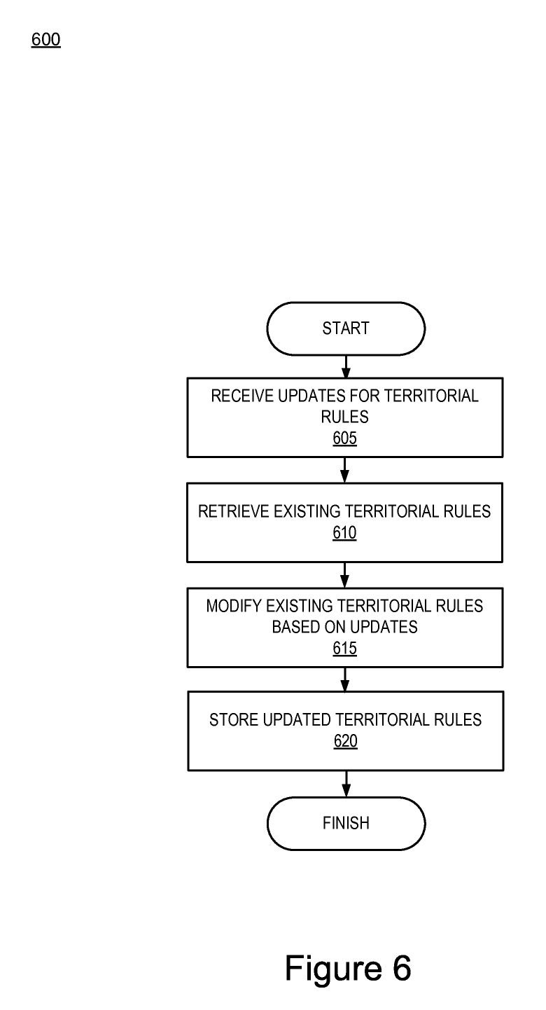

In one embodiment, the clearance module 195 also keeps track of which entities can provide which licenses and tracks changes to the laws of the different territories. A method for tracking changes to the laws of different territories is described in further detail below with reference to FIG. 6. In one embodiment, the clearance module 195 includes code and routines for providing one or more of the functionalities described below with reference to FIGS. 4A, 4B, 5A-5C and 6. The clearance module 195 is described in more detail below.

The network 122 is a conventional type of network, wired or wireless, and may have any number of configurations such as a star configuration, token ring configuration or other configurations known to those skilled in the art. In one embodiment, the network 122 comprises one or more of a local area network (LAN), a wide area network (WAN) (e.g., the Internet), and/or any other interconnected data path across which multiple devices communicate. In another embodiment, the network 122 is a peer-to-peer network. The network 122 is coupled to or includes portions of a telecommunications network for sending data in a variety of different communication protocols. For example, the network is a 3G network or a 4G network. In yet another embodiment, the network 122 includes Bluetooth communication networks or a cellular communications network for sending and receiving data such as via short messaging service (SMS), multimedia messaging service (MMS), hypertext transfer protocol (HTTP), direct data connection, wireless application protocol (WAP), email, etc. In yet another embodiment, all or some of the links in the network 122 are encrypted using conventional encryption technologies such as secure sockets layer (SSL), secure HTTP and/or virtual private networks (VPNs).

In the illustrated embodiment, the asset hosting site 100 is communicatively coupled to the network 122 via signal line 113. The content provider 118 is communicatively coupled to the network 122 via signal line 101. The client 120 is communicatively coupled to the network 122 via signal line 103. The publisher 170 is communicatively coupled to the network 122 via signal line 105. The label 172 is communicatively coupled to the network 122 via signal line 107. The author 174 is communicatively coupled to the network 122 via signal line 109. The publishing rights administrator 176 is communicatively coupled to the network 122 via signal line 111. The payment server 186 is communicatively coupled to the network 122 via signal line 115. The service server 198 is communicatively coupled to the network 122 via signal line 197.

The asset hosting site 100 is any system that allows a user to access an intellectual property asset via searching and/or browsing interfaces. An example of an asset hosting site 100 is the YOUTUBE™ website, found at www.youtube.com. Other asset hosting sites are known as well, and are adapted to operate according to the teachings disclosed herein. It will be understood that the term “web site” represents any computer system adapted to serve content using any internet working protocols, and is not intended to be limited to content uploaded or downloaded via the Internet or the HTTP protocol.

In one embodiment, the asset hosting site 100 is configured to receive and share all or a portion of an intellectual property asset. Examples of an intellectual property asset include, but are not limited to: a video; a song; a video game; a book; etc. Those skilled in the art will recognize that an intellectual property asset can be represented in any media type and/or file type. For example, the asset hosting site 100 shares content such as a video file, an audio file (e.g., one or more songs), a file that includes a combination of video and audio, an image file such as a JPEG or GIF file, a file including a video game program and/or a text file. An intellectual property asset is referred to as “an asset” hereinafter.

In one embodiment, sources of assets provided by the asset hosting site 100 are from uploads of assets by users, searches or crawls of other web sites or databases of assets, or the like, or any combination thereof. For example, in one embodiment, an asset hosting site 100 is configured to allow uploads of assets by users. In another embodiment, the asset hosting site 100 is configured to only obtain assets from other sources by crawling such sources or searching such sources in real time.

In the illustrated embodiment, the asset hosting site 100 includes: a front end interface 102; an asset serving module 104; an asset search module 106; an upload server 108; a presentation module 110; a thumbnail generator 112; a user database 114; an asset database 116; a graphical user interface module 126 (“GUI module 126”); an ownership database 128; an asset usage database 192; a graphical database 194; a rules database 196; and a clearance module 195. In one embodiment, the asset hosting site 100 further comprises a payment system 190. Here, the payment system 190 is depicted by a rectangle formed from a dashed line to indicate that in one embodiment the payment system 190 is comprised within the payment server 186. The components of the asset hosting site 100 are communicatively coupled to each other. For example, the components are communicatively coupled to one another via a bus (not pictured). Other conventional features, such as firewalls, load balancers, authentication servers, application servers, failover servers, site management tools, and so forth are not shown so as not to obscure the feature of the system.

In one embodiment, the illustrated components of the asset hosting website 100 are implemented as single pieces of software or hardware or as multiple pieces of software or hardware. In general, functions described in one embodiment as being performed by one component, can also be performed by other components in other embodiments, or by a combination of components. Furthermore, functions described in one embodiment as being performed by components of the asset hosting site 100 are performed by clients 120 or other entities in other embodiments if appropriate. In one embodiment, the functionality attributed to a particular component is performed by different or multiple components operating together.

In one embodiment, each of the various servers and modules is implemented as a server program executing on a server-class computer comprising one or more central processing units (“CPU,” or “CPUs” if plural), memory, network interface, peripheral interfaces, and other well-known components. The computers themselves preferably run an open-source operating system such as LINUX, have generally high performance CPUs, 1 gigabyte or more of memory, and 100 gigabyte or more of disk storage. In one embodiment, other types of computers are used, and it is expected that as more powerful computers are developed in the future, they are configured in accordance with the teachings disclosed herein. In another embodiment, the functionality implemented by any of the elements is provided from computer program products that are stored in tangible computer accessible storage mediums (e.g., random access memory (“RAM”), flash, hard disk, optical/magnetic media, or solid-state drive (“SSD”), etc.).

The front end interface 102 is an interface that handles communication with one or more of the content provider 118, the client 120, the publisher 170, the label 172, the author 174, the publishing rights administrator 176 and the payment server 186 via the network 122. For example, the front end interface 102 receives an asset uploaded from the content provider 118 and delivers the asset to the upload server 108. In one embodiment, the front end interface 102 receives requests from users of the client devices 120 and delivers the requests to the other components of the asset hosting site 100 (e.g., the asset search module 106 or the asset serving module 104). For example, the asset is a video and the front end interface 102 receives a video search query from a user and sends the video search query to the asset search module 106.

The upload server 108 receives one or more assets from the content provider 118 via the front end interface 102. For example, the upload server 108 receives one or more of a video file, an audio file (e.g., one or more songs), a file that includes a combination of video and audio, an image file such as a JPEG or GIF file, a file including a video game program and/or a text file from the content provider 118. In one embodiment, the upload server 108 processes the one or more assets and stores the processed assets in the asset database 116. The upload server 108 assigns an asset identification (“asset ID”) to the stored asset. An asset ID includes identifiers for videos (“a video ID”), songs (“a song ID”), images (“an image ID”), video games (“a video game ID”) and books (“a book ID”). For example, the upload server 108 assigns a video ID to a video and stores the video together with the video ID in the asset database 116. In other embodiments, the upload server 108 performs one or more of: formatting an asset; compressing an asset; metadata tagging an asset; content analysis, etc.

The asset database 116 is a storage system that stores assets shared by the asset hosting site 100 with the users. In one embodiment, the asset database 116 stores the assets processed by the upload server 108. In another embodiment, the asset database 116 also stores metadata associated with the assets. The metadata includes one or more of: a title; a description; tag information; a time length; and the like. In one embodiment, some or all of the metadata of the assets is provided by the content provider 118. For example, a user of the content provider 118 provides a title and a description of an asset when uploading the asset to the asset hosting site 100.

The asset search module 106 is code and routines that, when executed by a processor (not pictured), processes any search queries received by the front end interface 102 from users. A search query received by the front end interface 102 from a user includes search criteria such as keywords that identify an asset the user is interested in. The asset search module 106 uses the search criteria to query the metadata of the asset stored in the asset database 116. The search results for the query are returned to the front end interface 102 for presentation to the user. For example, if a user provides the front end interface 102 with a keyword search query, the asset search module 106 identifies an asset stored in the asset database 116 related to the keyword and returns the search result (e.g., asset IDs and/or metadata such as titles, descriptions, thumbnails of the identified assets) to the front end interface 102.

The asset serving module 104 is code and routines that, when executed by a processor (not pictured), processes requests for an asset (e.g., a video, a book, a picture, a music file, etc) and provides the asset to users. For example, the asset serving module 104 receives a query from a user via the front end interface 102, retrieves a set of videos from the asset database 116 based at least in part on the query and presents the set of videos to the user via the front end interface 102.

In one embodiment, the asset serving module 104 receives a request from a user to access an asset when the user clicks on a link to the asset. The request received from the user includes the asset ID of the asset that the user wishes to access. In one embodiment, the asset ID is included automatically in the request once the user clicks on the link for the asset. The asset serving module 104 uses the asset ID to search and locate the asset in the asset database 116. Once the requested asset is located, the asset serving module 104 transmits the asset to the user via the front end interface 102. The asset is presented to the user on a web page. Metadata associated with the asset is also presented with the asset, such as the title and description of the asset. In one embodiment, the asset serving module 104 stores the asset ID of the asset in the user database 114 after sending the asset to the user so that an asset access history of the user is stored in the user database 114.

The user database 114 is a storage system that stores data and/or information associated with a user. For example, the user database 114 stores the asset IDs of assets uploaded by a user to the asset hosting site 100 and the asset IDs of assets that the user has accessed from the asset database 116. In one embodiment, the user is identified by using a login name and password and/or by using the user's internet protocol (“IP”) address.

The thumbnail generator 112 is code and routines that generates a thumbnail for an asset. A thumbnail is a picture that represents an asset in the asset hosting site 100. For example, assume the asset is a video. The thumbnail generator 112 analyzes the video and selects a frame of the video as the thumbnail. In one embodiment, the thumbnail generator 112 provides one or more pictures for the video and the user uploading the video to the asset hosting site 100 selects one picture as the thumbnail.

The ownership database 128 is a storage system that stores the ownership information. The ownership information includes one or more of the following: an identifier of an entity owning a right for an asset (e.g., a name of an owner); an identifier of the territory in which the ownership of a right applies; a percentage of ownership of a right claimed by the entity; an identifier of an administrator (e.g., a name of the administrator) that sets an administrative policy for a right; a policy assigned to one or more rights for the asset set by the administrator; a timestamp; and one or more geographic identifiers of the owner of a right.

A right for an asset includes one of a public performance right, a reproduction right, a distribution right, a synchronization right (“a sync right”) and a right to make a derivative work. Rights for an asset are territory specific. For example, a first entity may own the distribution right for an asset in the territory of the United States while, at the same time, a second entity owns the distribution right for the same asset in a different territory such as Brazil, India, China, Japan, etc.

The GUI module 126 is code and routines that, when executed by a processor (not pictured), provides graphical data for generating a GUI used by a human user to input ownership information. For example, the GUI module generates graphical data for providing a GUI to a publisher 170, allowing a human user operating on the publisher 170 to edit ownership information of an asset. The GUI module 126 is configured to transmit the graphical data to the front end interface 102. In one embodiment, the GUI module 126 stores the graphical data in the graphical database 194. The front end interface 102 communicates with the network 122 to transmit the graphical data to a processor-based computing device communicatively coupled to the network 122. For example, the front end interface 102 transmits the graphical data to the publisher 170. The publisher 170 receives the graphical data and generates a GUI displayed on a display device (e.g., a monitor) communicatively coupled to the processor-based computing device. The GUI is displayed on a display device and viewed by a human user operating on the publisher 170. The GUI includes one or more fields, drop down boxes or other conventional graphics used by the human user to input or edit the ownership information. Data inputted into the GUI is received by the front end interface 102 and stored in the ownership database 128.

The graphical database 194 is a non-transitory computer-readable storage medium that stores graphical data used to provide one or more user interfaces. For example, the graphical database 194 stores graphical data generated by the GUI module 126 for providing a GUI to a publisher 170 to add ownership information for an asset. One skilled in the art will recognize that the graphical database 194 may store other graphical data generated by the GUI module 126.

The clearance module 195 is code and routines for providing rights clearance for a service provided by a service provider in a territory. A service provider is an entity providing one or more services to users in one or more territories. For example, a service provider provides a service such as streaming a video or a piece of music for a user, selling an asset to a user, renting an asset to a user, making a copy of an asset for a user and storing an asset for a user, etc. In one embodiment, the service provider is an entity operating on the asset hosting site 100. In other embodiments, the service provider is an entity operating on one of the client 120, the author 174, the label 172, the publisher 170 and the content provider 118.

The clearance module 195 receives a description of an asset, a description of a service associated with the asset and a description of a territory in which the service is provided (e.g., a jurisdiction for the service, such as the United States, Brazil, India, China, etc.) from a service provider. The clearance module 195 retrieves one or more territorial rules from the rules database 196 and determines one or more territorial requirements for the specified combination of the territory and the service based at least in part on the one or more territorial rules. For different pairs or combinations of services and territories associated with an asset, the clearance module 195 determines different sets of territorial requirements for the pairs of services and territories.

A territorial rule is data describing the requirements for one or more of the laws of a territory. In one embodiment, the law described by the territorial rule is a copyright law or any other law describing which rights are required to provide a service in a territory. For example, a territorial rule describes which rights are required to provide a service in a territory. The territorial rule is used by the clearance module 195 to determine which licenses are needed to provide a service in a territory.

As is known in the art, in some territories one or more rights can only be licensed by entities specified by the law. For example, the law of a territory requires a right to be licensed from a publishing rights administrator 176. In yet another embodiment, the territorial rule includes a group of entities from which a service provider is able to purchase a license for a right in a territory. For example, a territorial rule describes that a service provider may purchase a license for a synchronization right associated with a music video in Brazil from one of the publisher 170, the label 172, the author 174 and the publishing rights administrator 176. In one embodiment, the territorial rule describes how much a license for a right will cost. For example, the law of the territory requires a license for a right to be obtained from a publishing rights administrator 176 and sets the fee for the license at some amount. Data describing the cost of licensing a right is referred to herein as “pricing data.” In one embodiment, the pricing data is acquired from existing licensing agreements or any other source of the fees for acquiring a license.

A territorial requirement is a combination of all the territorial rules applied to providing a service associated with an asset in a specified territory. For example, the clearance module 195 retrieves a first territorial rule and a second territorial rule. The first territorial rule describes that a license for a distribution right is required to provide a first service in the France (or some other territory) and the second territorial rule describes that a license for the distribution right in France is required to be purchased from the publishing rights administrator 176. The clearance module 195 combines the first and second territorial rules and generates a territorial requirement describing that a service provider providing the first service in the territory of France needs a license for a distribution right and the distribution right is required to be licensed from the publishing rights administrator 176.

The term “bundle of rights” describes, for a particular service in a particular territory, the rights that a service provider must have licensed in order to provide the service. The term “licensor” describes the entity that the license is purchased from. For example, the content provider 118, publisher 170, label 172, author 174 or publishing rights administrator 176 is a licensor. The entity purchasing the license can be referred to as a “licensee.”

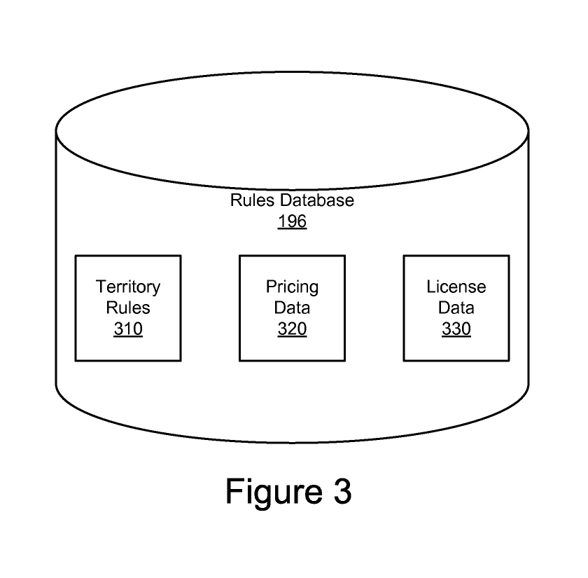

As described below, the territorial rules and the territorial requirements are stored in the rules database 196. In one embodiment, the pricing data is also stored in the rules database 196. In one embodiment, the rules database 196 also stores data describing the existing licensing agreements for the asset hosting site 100 and the terms of these agreements. Data describing the existing licensing agreements and the terms of these agreements is referred to herein as “license data.” The rules database 196 is described in more detail with reference to FIG. 3.

The clearance module 195 determines, for a specific service in a specific territory, which rights are required (i.e., the required bundle of rights). In one embodiment, the clearance module 195 makes this determination based at least in part on the territory rules. The clearance module 195 determines which rights are already licensed by the service provider (e.g., asset hosting site 100) based at least in part on the license data. The clearance module 195 determines, based at least in part on the required bundle of rights and the rights already licensed, which rights from the bundle of rights the asset hosting site 100 needs to acquire in order to legally provide a particular service in a particular territory.

In one embodiment, if the existing licensing agreements do not meet the requirements of the territory, the clearance module 195 determines a preferred licensor for the service provider to purchase a license from. A preferred licensor is a licensor that a service provider prefers more than other licensors. A licensor is identified as a preferred licensor for any reason. In one embodiment, an administrator of the asset hosting site 100 provides one or more inputs to the clearance module 195 that identify one or more preferred licensors and the clearance module identifies a preferred licensor based on this input. In another embodiment, a preferred licensor is determined based on economic considerations. For example, a preferred licensor is a licensor that provides a license for a right in a specified territory for an asset with lower cost than other licensors. In another example, a preferred licensor is a licensor that has an existing licensing agreement with a service provider. In yet another embodiment, a preferred licensor is described by a territory rule specifying a particular licensor (e.g., a publishing rights administrator 176) that has exclusive power to issue a license for a right in a specified territory.

The rules database 196 is a non-transitory computer-readable storage medium that stores one or more of territorial rules, license data and pricing data. In one embodiment, the rules database 196 stores different territorial rules associated with different combinations of services and territories in different sectors. For example, the rules database 196 stores a first set of territorial rules associated with a first pair of a service and a territory in a first sector of the database and a second set of territorial rules associated with a second pair of a service and a territory in a second sector of the database. The rules database 196 also stores an association between a territorial rule and a pair of a service and a territory. The rules database 196 is further described below with reference to FIG. 3.

The asset usage database 192 is a non-transitory computer-readable storage medium that stores usage data of an asset, revenue data of an asset and payment data for purchasing a license for a right in a territory for an asset. The usage data describes usage of one or more rights for an asset. For example, the usage data includes a description of instances in which a right for an asset is used, an identifier of a licensor for the right, a territory that the license is applied and an identifier of a service provider that uses the right, etc. The revenue data is data describing revenue generated by monetizing an asset. For example, the revenue data includes income generated by associating an advertisement with the asset, selling copies of the asset or renting the asset to users. The payment data is data describing how much a licensor issuing a license for a right associated with an asset in a territory is compensated. In one embodiment, the payment data also includes information about an escrow account that a service provider is used to pay the licensor.

The payment system 190 is code and routines for sending a payment to a licensor. For example, the payment system 190 retrieves the payment data and information about an escrow account from the asset usage database 192 and pays the licensor using an escrow account based on the payment data. In one embodiment, the payment system 190 is comprised within the asset hosting site 100. In another embodiment, the payment system 190 is comprised within the payment server 186. The payment server 186 is described in more detail below.

The presentation module 110 is code and routines that, when executed by a processor (not pictured), presents any information intended for a user to a corresponding client device such as the client 120. For example, the presentation module 110 generates a graphic associated with the assets stored in the asset database 116 or the ownership information stored in the ownership database 128 and sends the graphic to a web browser (not pictured) installed in the client 120 via the front end interface 102 and the network 122.

The content provider 118 is any device that provides assets to the asset hosting site 100. For example, the content provider 118 is a computing device that uploads an asset to the asset hosting site 100. In one embodiment, the content provider 118 is also one of the client 120, the publisher 170, the label 172, the author 174 and the publishing rights administrator 176. In yet another embodiment, the content provider 118 is the same entity that operates the asset hosting site 100.

In one embodiment, the content provider 118 is configured to operate a computing device to perform various content provider functions. Examples of the content provider functions include, but are not limited to: uploading an asset to the asset hosting site 100; editing an asset stored by the asset hosting site 100; removing an asset from the asset hosting site 100; and editing content provider preferences associated with an asset.

The client 120 is any processor-based computing device. The client 120 executes client software such as a web browser or built-in client application and connects to the asset hosting site 100 via the network 122. In one embodiment, the client 120 includes a variety of different computing devices. Examples of a client device 120 include, but are not limited to: a personal computer; a personal digital assistant; a television set-up box; a tablet computer; a cell phone (e.g., a smart phone); and a laptop computer. The client 120 comprises a processor (not pictured), a memory (not pictured) and other components conventional to a computing device.

In one embodiment, the client 120 is configured as a content provider 118 to provide assets to the asset hosting site 100. In another embodiment, the client 120 is one of the publisher 170, the label 172, the author 174 and the publishing rights administrator 176. In yet another embodiment, the client 120 is configured to retrieve assets stored by the asset hosting site 100. For example, the client 120 includes an embedded video player (e.g., the Flash™ player from Adobe System, Inc.) adapted for the video content formats used in the asset hosting site 100 so that a user is able to view a video from the asset hosting site 100 using the embedded video player. In yet another embodiment, the client 120 is a service provider for providing one or more services to other users.

The publisher 170 is any entity that publishes an asset. In one embodiment, the publisher 170 is any processor-based computing device that publishes an asset on a website, an application store, etc. In another embodiment, the publisher 170 refers to a human user that operates the computing device to publish the asset without causing any confusion. In one embodiment, the publisher 170 owns one or more rights for an asset in a specified territory and is able to issue a license for the right in the territory. For example, the publisher 170 owns a reproduction right for a video in the United States and has the power to issue a license for the reproduction right for the video in the United States. In one embodiment, the publisher 170 can own and issue licenses for any other rights for the asset. In yet another embodiment, the publisher 170 owns a portion of a right for an asset in a specified territory. For example, the publisher 170 owns 50% of a distribution right of a video in the United States.

The label 172 is an entity that manages one or more of the production, manufacture, distribution, marketing and protection of an asset. In one embodiment, the label 172 is any processor-based computing device that provides the one or more of the functionalities of a music label, television studio, movie studio, etc. In another embodiment, the label 172 is a human operating the computing device on behalf of music label, television studio, movie studio, etc.

In one embodiment, the label 172 owns one or more rights of an asset in a specified territory and is able to issue a license for the right in the territory. For example, the label 172 owns a distribution right for a music video in the United States and has the power to issue a license for the distribution right for the video in the United States. In another embodiment, the label 172 owns a portion of a right for an asset in a specified territory. For example, the label owns 50% of a distribution right of a song in the United States.

The author 174 is an entity that creates an asset. For example, the author 174 is one of a composer that composes a piece of music, a writer that writes an article, a film maker that films a video, etc. In one embodiment, the author 174 is any processor-based computing device operated by one or more of the composer, writer, a film maker, etc. In one embodiment, the author 174 owns a right for an asset in a specified territory and is able to issue a license for the right in the territory. In another embodiment, the author 174 owns a portion of a right for an asset in a specified territory.

The publishing rights administrator 176 is an entity that issues licenses for rights to a service provider in one or more territories and collects royalties or payment for the issued licenses from the service provider. In one embodiment, the publishing rights administrator 176 is any processor-based computing device operated by a human on behalf of a publishing rights administrator entity.

The payment server 186 is any hardware server device. For example, the payment server 186 is a hardware server operated by Google® of Mountain View, Calif. In one embodiment, the payment server 186 provides payment information to a licensor from which a service provider purchases a license for a right in a territory. For example, the payment server 186 retrieves payment data from the asset usage database 192 and sends a payment to a licensor via the network 122. In one embodiment, the payment server 186 comprises a payment system 190.

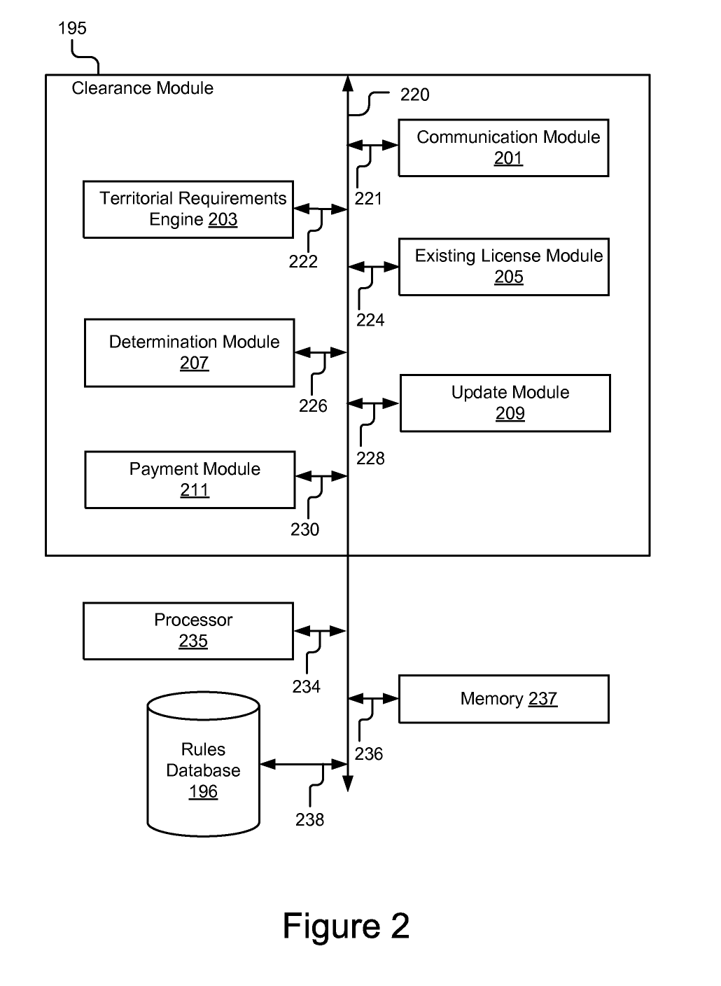

The above-described system 130 is advantageous because, for example, it provides a framework for providing clearance of granular rights for a variety of services offered by a variety of service providers in various territories. Furthermore, the system 130 takes a group of factors into consideration when determining which entity to purchase a license for a right in a territory, which is also beneficial because the system 130 is able to select a licensor that meets the service provider's interests as further described below with reference to FIG. 2.

### Clearance Module

Referring now to FIG. 2, the clearance module 195 is shown in more detail. FIG. 2 is a block diagram illustrating the clearance module 195 according to one embodiment. The processor 235 comprises an arithmetic logic unit, a microprocessor, a general purpose controller or some other processor array to perform computations, retrieve data stored on the memory 237, etc. The processor 235 is coupled to the bus 220 for communication with the other components. Processor 235 processes data signals and may comprise various computing architectures including a complex instruction set computer (CISC) architecture, a reduced instruction set computer (RISC) architecture, or an architecture implementing a combination of instruction sets. Although only a single processor is shown in FIG. 2, multiple processors may be included. The processing capability may be limited to supporting the display of images and the capture and transmission of images. The processing capability might be enough to perform more complex tasks, including various types of feature extraction and sampling. It will be obvious to one skilled in the art that other processors, operating systems, sensors, displays and physical configurations are possible. The processor 235 is communicatively coupled to the bus 220 via signal line 234.

The memory 237 stores instructions and/or data that are executed by the processor 235. The memory 237 is communicatively coupled by the bus 220 for communication with the other components of clearance module 195. In one embodiment, the instructions and/or data comprises code for performing any and/or all of the techniques described herein. The memory 237 is a dynamic random access memory (DRAM) device, a static random access memory (SRAM) device, flash memory or some other memory device known in the art. In one embodiment, the memory 237 also includes a non-volatile memory or similar permanent storage device and media such as a hard disk drive, a floppy disk drive, a compact disc read only memory (CD-ROM) device, a digital versatile disk read only memory (DVD-ROM) device, a digital versatile disk random access memories (DVD-RAM) device, a digital versatile disk rewritable (DVD-RW) device, a flash memory device, or some other non-volatile storage device known in the art. The memory 237 is communicatively coupled to the bus 220 via signal line 236.

The clearance module 195 comprises a communication module 201, a territorial requirements engine 203, a determination module 207, an existing license module 205, an update module 209 and a payment module 211. The components of the clearance module 195 are communicatively coupled to each other via the bus 220. In one embodiment, the clearance module 195 is implemented using hardware such as field-programmable gate arrays (“FPGAs”) or application-specific integrated circuits (“ASICs”). One skilled in the art will recognize that the clearance module 195 may include different modules and/or components to provide the functionality described herein.

The communication module 201 is code and routines that, when executed by the processor 235, handles communication between components of the clearance module 195 and other components of the asset hosting site 100. The communication module 201 also handles communication between the territorial requirements engine 203, the determination module 207, the existing license module 205, the update module 209 and the payment module 211. In the depicted embodiment, the communication module 201 is communicatively coupled to the bus 220 via signal line 221.

The communication module 201 receives a description of an asset, a description of a service and a description of a territory from a service provider operating on a computing device (e.g., a client 120) and sends the descriptions to the territorial requirements engine 203. In one embodiment, the communication module 201 receives updates from an administrator and sends the updates to the update module 209. In another embodiment, the communication module 201 receives payment data from the payment module 211 and sends the payment data to the payment system 190. In yet another embodiment, the communication module 201 receives a message from the existing license module 205 or the determination module 207 and sends the message to the service provider.

The territorial requirements engine 203 is code and routines when executed by the processor 235 for determining one or more territorial requirements for a service provided in a territory. For example, the territorial requirements engine 203 determines one or more territorial requirements for a specified pair of a service and a territory associated with an asset. The territorial requirements engine 203 is communicatively coupled to the bus 220 via signal line 222.

The territorial requirements engine 203 receives a description of an asset (e.g., a video), a description of a service (e.g., renting the video) and a description of a territory in which the service is provided (e.g., the United States) from the service provider 199 via the communication module 201 and the bus 220. The territorial requirements engine 203 retrieves one or more territorial rules from the rules database 196 based on the descriptions of the service and the territory. For example, the territorial requirements engine 203 retrieves a set of territorial rules that match to the service and the territory from the rules database 196 via the bus 220. The rules database 196 is communicatively coupled to the bus 220 via signal line 238.

In one embodiment, the territorial requirements engine 203 determines one or more territorial requirements for the pair of the service and the territory using the one or more territorial rules. In one embodiment, the territorial requirements engine 203 generates one or more territorial requirements by interpreting and combining the one or more territorial rules. For example, the territorial requirements engine 203 retrieves: (1) a first territorial rule describing that licenses for a first right and a second right are required to provide a service for an asset in a territory; (2) a second territorial rule describing that a license for the second right is required to be licensed from the publishing rights administrator 176; and (3) a third territorial rule describing that a license for the first right is required to be licensed from one of the author 174 and the label 172. The territorial requirements engine 203 combines the three territorial rules to form a territorial requirement describing that the first and second rights are required to provide the service for the asset in the territory, that the first right must be licensed from the publishing rights administrator 176 and that the second right must be licensed from one of the author 174 and the label 172.

The territorial requirements engine 203 sends the one or more territorial requirements to the determination module 207 and the existing license module 205.

The existing license module 205 is code and routines for determining whether the service provider 199 already has one or more existing licenses for specified asset in the specified territory, whether these existing licenses meet the determined territorial requirements and, if the territorial requirements are one or more existing licenses for one or more rights required for providing a service in a territory. The existing license module 205 is communicatively coupled to the bus 220 via signal line 224.

The existing license module 205 receives a description of the territorial requirements from the territorial requirements engine 203. The territorial requirements determined by the territorial requirements engine 203 include a description of the required bundle or rights in order to provide the specified service in the specified territory. As described above, the bundle of rights includes a data describing one or more rights required to provide the specified service in the specified territory.

For the purpose of clarity, an individual right in the bundle of rights is referred to as a “required right.” The service provider 199 specifies a service to be provided for an asset in a territory. A required right describes a right from the determined bundle of rights that is required to legally provide specified service, for specified asset, in the specified territory. For example, if the service provider 199 wants to stream a particular song in Brazil, the territorial requirements engine 203 determines, based on the laws of Brazil, one or more rights that are required to stream that song in Brazil. Assume the territorial requirements engine 203 determines that a distribution right and a sync right are required in Brazil. This set of rights is referred to as the bundle of rights. The individual rights in the bundle of rights are referred to as “required rights,” i.e., the territorial requirements engine 203 determines that for the combination of streaming this song in Brazil, the distribution right for this asset in Brazil is a required right and the sync right for this song in Brazil is a required right.

For each required right, the existing license module 205 determines, based on the license data, whether there is an existing license for the required right. For example, the existing license module 205 searches the license data stored in the rules database 196 and determines, for one or more of the required rights, whether the service provider 199 has an existing license for the required right. The existing license module 205 retrieves all the existing licenses matching a required right from the license data 330. The license data 330 is described below with reference to FIG. 3.

In one embodiment, the license data 330 includes data describing existing licenses for all the required rights. In another embodiment, there are existing licenses for some but not all of the required rights. Responsive to determining that the existing licenses do not include a particular required right, then that required right is referred to as a “missing right.” For example, if a first, second and third right are required, but the existing license module 205 determines that only the first and third right are covered by the existing licenses represented by the license data, then the second right is referred to as a missing right. Although there is only one missing right in this example, in practice there can be any number of missing rights. Missing rights are described in more detail below.

In one embodiment, one or more of the existing licenses includes cap data describing the number of times the right can be used. For example, an existing license describes that a sync right can only be used 10,000 times. Assume that this means that a song covered under that license can only be downloaded 10,000 times. Once the service provider 199 has downloaded the song 10,000 times, a new license is required. Such cap data is included in the license data. The number of times a right has been used (e.g., the number of times a song has been downloaded) is stored in the asset usage database 192. The existing license module 205 checks the license data to determine any cap data and compares the cap data to the usage data stored in the asset usage database 192 to determine whether a new license is required. For example, assume that the cap data caps the number of downloads of a song at 10,000. The existing license module 205 retrieves the license data and determines the cap data from the license data. The existing license module 205 queries the asset usage database 192 and determines that the song has been downloaded 9,992 times. Based on this determination, the existing license module 205 determines that a new license is not needed.

In one embodiment, the existing license module 205 determines that an existing right is not valid because it was obtained from an entity that is not allowed under one or more territorial rules. For example, assume that a service associated with an asset is provided in Brazil and there is an existing license for a required right issued by the publisher 170 and applied all over the world. However, a territorial requirement for providing the service in France indicates that a license for the required right associated with the asset is required to be issued by a local publishing rights administrator 176 in France and any other licenses issued by other licensors are not valid. The existing license is therefore a missing right, and the existing license module 205 determines that the existing license described by the license data does not meet the territorial requirement for providing the service to users in France because the existing license is issued by the publisher 170 rather than the local publishing rights administrator 176. In one embodiment, the existing license module 205 communicates with one or more of the other elements of the clearance module 195 to achieve (or attempt to achieve) the purchase of the missing license from the local publishing rights administrator 176 in France. In another embodiment, the service provider 199 is not an element of the asset hosting site 100 and the existing license module 205 communicates with one or more of the other elements of the of the clearance module 195 and the front end interface 102 to communicate a message to the service provider 199 that a new license is required for the missing license.

In one embodiment, the existing license module 205 determines that there is at least one existing license for each required right. In another embodiment, the service provider 199 is not an element of the asset hosting site 100 and the existing license module 205 communicates with one or more of the other elements of the of the clearance module 195 and the front end interface to communicate a message to the service provider 199 that no new licenses are required.

In one embodiment, responsive to determining that the service provider 199 owns a license for the bundle of rights, the asset hosting site 100 takes steps to monetize the asset in the territory by providing the specified service to users in the territory.

In one embodiment, the existing license module 205 determines that there is at least one missing right. The existing license module 205 sends a message to the determination module 207 describing the missing rights.

The determination module 207 is code and routines that, when executed by the processor 235, determines a preferred licensor for a missing right. For example, the determination module 207 is communicatively coupled to the bus 220 via signal line 226. The determination module 207 receives a description of one or more missing rights from the existing license module 205 via the bus 220. The determination module 207 determines which licensor offers a license for a missing right at the lowest fee or according to any other criteria for determining a preferred licensor.

For each missing right, the determination module 207 determines whether the territory requires clearance of the missing right by a particular publishing rights administrator 176 based on the one or more territorial requirements. For example, the determination module 207 parses the one or more territorial requirements to extract any designated licensor for the missing right in the territory.

In one embodiment, if the territorial requirements engine 203 determines that the territory requires the missing right to be licensed from the publishing rights administrator 176, the determination module 207 determines whether there is an existing licensing agreement with the publishing rights administrator 176 in the territory. For example, the determination module 207 searches the license data 330 and determines whether there is an existing license agreement with the publishing rights administrator 176 for the missing right. If there is an existing licensing agreement, the determination module 207 retrieves information about the existing licensing agreement from the license data 330 and sends the information to the payment module 211. If there is no existing licensing agreement with the publishing rights administrator 176, in one embodiment the determination module 207 communicates with one or more of the other elements of the clearance module 195 to identify a preferred licensor for the missing right.

In one embodiment, the determination module 207 determines whether an administrator of the service provider 199 authorizes monetization of the asset without a license for one or more missing rights. If an administrator of the service provider 199 authorizes monetization of the asset with missing rights, the service provider 199 takes steps to monetize the asset even though there are missing rights. The service provider 199 can place money in an escrow account for the owner of the missing rights or take other steps to attempt to pay the owner of the missing rights. The system 130 does not monetize the asset if the administrator does not authorize monetization of the asset without a license.

In one embodiment, the territory does not require clearance of the missing right by the publishing rights administrator 176. The determination module 207 determines one or more licensors for the missing right. The determination module 207 determines one or more of the publisher 170, the label 172, the author 174 and the publishing rights administrator 176 to be a preferred licensor for purchasing the missing right from.

The determination module 207 retrieves licensing data and pricing data from the rules database 196 associated with the one or more entities. For example, the determination module 207 retrieves data describing one or more existing license agreements with the one or more licensors from the license data 330. The determination module 207 determines data describing fees for purchasing a license for the missing right from the one or more licensors from the pricing data 320. In one embodiment, the determined fees include the total cost of purchasing a license, including any government fees, attorney fees, etc. The license data 330 and the pricing data 320 are described in more detail with reference to FIG. 3.

The determination module 207 determines, based on one or more of the retrieved licensing data and pricing data, a preferred licensor to purchase a license from for a missing right. For example, in one embodiment the determination module 207 selects the publisher 170 as the preferred licensor for the missing right because there is a licensing agreement between the publisher 170 and the service provider 199 indicating that the service provider 199 pays a flat fee to the publisher 170 for some period of usage (e.g., lifetime usage) of the license in the territory. In other embodiments the determination module 207 selects the label 172 as the preferred licensor for the missing right because the label 172 provides discount rates for licenses for bundle of missing rights in the territory. A bundle of missing rights is two or more missing rights. In one embodiment, the determination module 207 identifies more than one entity as a candidate for being a preferred licensor for a missing right and an administrator of the service provider 199 selects a preferred licensor from list of candidates.

In one embodiment, the determination module 207 determines a preferred licensor for the missing right in the territory for the asset based at least in part on one or more factors such as: a structure of a licensing agreement and revenue associated with the asset (e.g., a flat fee for purchasing a license, a marginal fee, a fee per use, a fee based on revenue share, a price for a licensing agreement with a licensor, etc.); a negotiated rate for a missing right or a bundle of missing rights (e.g., compared to purchasing a single license, the licensor requires a cheaper price per license if multiple licenses are purchased); a payment for recoupable advance; any unmet prepayment; and any external factors that affect payment to a licensor over another licensor (e.g., tax consideration, part of another licensing agreement, etc.), etc.

The determination module 207 sends data describing the preferred licensor (e.g., an identifier of the preferred licensor) to the payment module 211. In one embodiment, the determination module 207 sends information about a licensing agreement with the preferred licensor to the payment module 211. The payment module 211 then uses this data to determine how much to pay the preferred licensor.

The payment module 211 is code and routines for determining a payment to a licensor that a license for a missing right in a territory for an asset is purchased from. The payment module 211 is communicatively coupled to the bus 220 via signal line 230. In one embodiment, the payment module 211 is comprised within the payment system 190.

In one embodiment, the payment module 211 receives an identifier of the preferred licensor from the determination module 207 and retrieves pricing data and license data associated with the preferred licensor (e.g., prices for purchasing a license for a missing right in a territory for an asset, licensing agreements with the preferred licensor, etc.) from the rules database 196. The payment module 211 calculates a payment for purchasing a license for the missing right in the territory for the asset from the preferred licensor based on the pricing data and the license data and stores payment data describing the payment in the asset usage database 192. In one embodiment, the payment module 211 sends the payment data to the payment system 190. In another embodiment, the payment module 211 pays the preferred licensor based on the payment data and stores a record of the purchased license in the license data 330.

In another embodiment, the payment module 211 receives information about an existing licensing agreement with the publishing rights administrator 176 from the determination module 207. The payment module 211 retrieves pricing data associated with the existing licensing agreement from the pricing data 320. The payment module 211 calculates a payment for purchasing a license for the missing right from the publishing rights administrator 176 based at least in part on the pricing data and stores payment data describing the payment in the asset usage database 192. In one embodiment, the payment module 211 sends the payment data to the payment system 190. In another embodiment, the payment module 211 pays the publishing rights administrator 176 based on the payment data and stores a record of the purchased license in the license data 330.

The update module 209 is code and routines that, when executed by the processor 235, updates the territorial rules stored in the rules database 196. For example, the update module 209 includes instructions that, when executed by the processor 235, causes the processor 235 to generate graphical data for providing a GUI to an administrator. The graphical data is sent to a computing device (e.g., a processor-based device similar to the client 120) operated by the administrator causing a display of the computing device to display the GUI to the administrator. The administrator inputs data describing updates for one or more territorial rules via the GUI. The computing device sends the data describing the updates to the update module 209.

In one embodiment, the update module 209 includes a parser that parses websites describing territorial rules. The update module 209 determines data describing updates for the territorial rules stored in the rules database 196 based on the parsing of the websites.

The update module 209 updates the territorial rules stored in the rules database 196 based on the data describing the updates. For example, the update module 209 extracts one or more rule identifiers identifying one or more territorial rules from the update data. The update module 209 retrieves one or more existing territorial rules from the rules database 196 using the one or more rule identifiers and modifies the one or more existing territorial rules based on the update data. The update module 209 stores the updated territorial rules in the rules database 196. In one embodiment, if there is no existing territorial rule stored in the rule database 196 corresponding to a rule identifier included in the update data, the update module 209 extracts information associated with the rule identifier from the update data and stores the information as a new territorial rule in the territorial rules 310 of the rules database 196 in conjunction with the rule identifier.

### Rules Database

FIG. 3 is a block diagram illustrating one embodiment of a rules database 196. The rules database 196 stores, among other things, territory rules 310, pricing data 320 and license data 330.

The territory rules 310 are data describing one or more territorial rules. In one embodiment, the territorial rules 310 are stored in the rules database 196 based on the territories in which the territorial rules apply. For example, a first set of territorial rules for a first territory are stored in a first section of the territory rules 310 and a second set of territorial rules for a second jurisdiction are stored in a second section of the territory rules 310. In one embodiment, the territory rules 310 also include rule identifiers for the territory rules. One skilled in the art will recognize that the territory rules 310 may include other data associated with the stored territory rules such as data describing the last time the territory rules 310 were updated.

The pricing data 320 are data associated with prices for purchasing licenses. For example, the pricing data 320 include data describing one or more prices for purchasing licenses for one or more missing rights from one or more licensors. In one embodiment, the pricing data 320 include data describing a flat fee for purchasing a license for a missing right, a marginal fee, a fee per use, a fee based on revenue share, a price for a licensing agreement with a licensor, a negotiated rate for a single missing right or multiple missing rights, a payment for recoupable advance, any unmet prepayment, etc.

The license data 330 are data describing one or more existing licenses for one or more rights. For example, the license data 330 include data describing one or more licenses for a bundle of rights for an asset in one or more territories. In one embodiment, the license data 330 also include data describing licensing agreements with one or more licensors such as a licensing agreement with the publishing rights administrator 176. In another embodiment, the license data 330 include data describing one or more external factors that influence payment to a licensor over another licensor such as tax considerations, etc.

### Methods

Referring now to FIGS. 4A, 4B, 5A-5C and 6, various embodiments of a method for clearing granular rights are described. FIGS. 4A and 4B are flow diagrams of a method 400 for clearing granular rights according to one embodiment.

Turning to FIG. 4A, the communication module 201 receives 401 a description of an asset, a description of a service associated with the asset and a description of a territory in which the service is provided from a service provider. The communication module 201 sends the description of the asset, the description of the service and the description of the territory to the territorial requirements engine 203. The territorial requirements engine 203 determines 405 one or more territorial requirements for providing the service associated with the asset to users in the territory. The territorial requirements engine 203 sends the one or more territorial requirements to the existing license module 205.

The existing license module 205 determines a required right for providing the specified service in the specified territory based at least in part on the determined territorial requirements. In one embodiment, the existing license module 205 determines a bundle of required rights and the method 400 performs steps 410-475 (except the monetization step 430) for each of the bundle of required rights before determining whether to monetize the asset.

The existing license module 205 determines 410 whether there are existing licenses for the required right. The existing license module 205 determines 420 whether any of the existing licenses for the required meets the territorial requirements. If there is at least one existing license meeting the territorial requirements for the required right in the territory, the method 400 moves to step 430. At step 430, the service provider 199 monetizes the asset by providing the service to users in the territory and the method 400 ends.

If none of the existing licenses for the required right meets the territorial requirements, the existing license module 205 determines that the required right is a missing right requiring clearance with a licensor in the territory and sends the missing right to the determination module 207. The method 400 moves to step 440.

At step 440, the determination module 207 determines whether the territory requires the missing right to be licensed from a particular entity such as a particular publishing rights administrator 176. If the license must be obtained from a publishing rights administrator 176, the method 400 moves to step 450. Otherwise, the method 400 moves to step 455. At step 450, the payment module 211 calculates a payment for purchasing a license for the missing right from the publishing rights administrator 176 and pays 450 the publishing rights administrator 176. The service provider 199 monetizes 430 the asset and the method 400 ends.

Turning to step 455, the determination module 207 determines whether a license for the missing right in the territory can be obtained. If a license is obtainable the method 400 moves to step 460. If not, the method 400 moves to step 475. At step 460, the determination module 207 determines which entity to purchase the license from. For example, the determination module 207 chooses a preferred licensor for purchasing a license for the missing right in the territory. At step 470, the payment module 211 calculates a payment for purchasing a license for the missing right in the territory from the chosen entity and pays the chosen entity. At step 430, the service provider 199 monetizes the asset and the method 400 ends.

Referring to FIG. 4B, the determination module 207 determines 475 whether an administrator of the system 130 authorizes monetization of the asset without a license for one or more missing rights. If the administrator authorizes monetization of the asset without a license for one or more missing rights, the method 400 moves to step 490. Otherwise, the method 400 moves to step 480. At step 480, the method 400 does not monetize the asset and the method 400 ends. At step 490, the method 400 monetizes the asset by providing the service to users in the territory. At step 495, the service provider 199 escrows a payment to cover one or more licenses for the one or more missing rights and the method 400 ends.

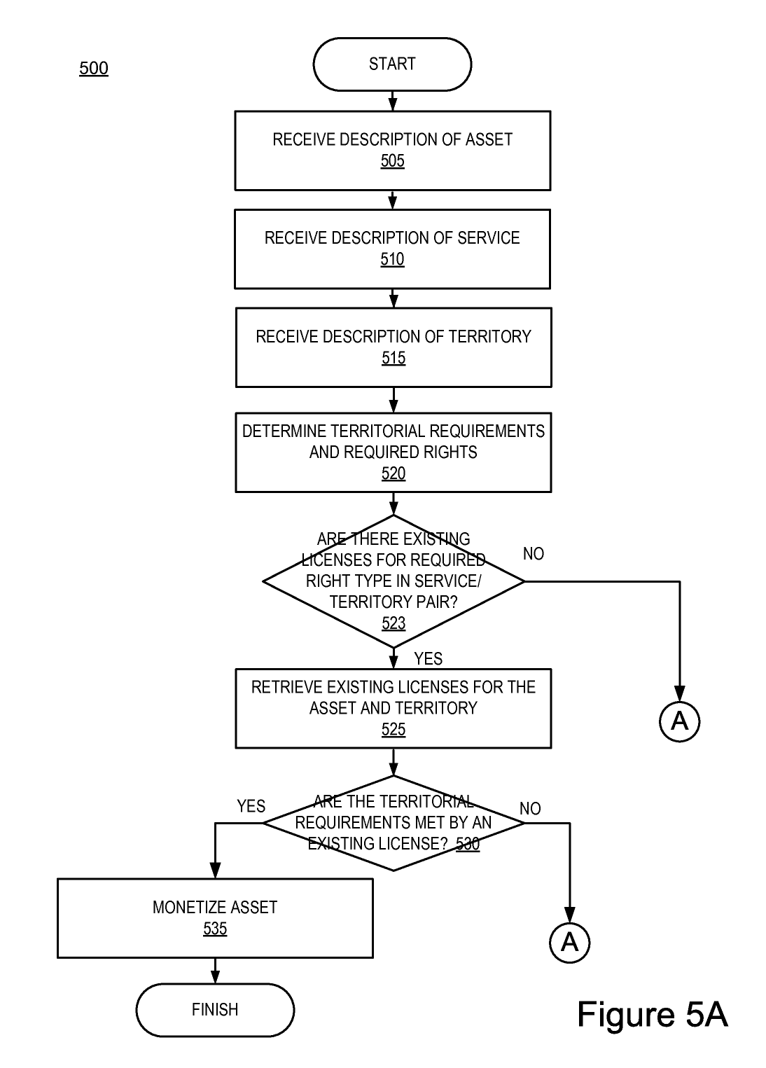

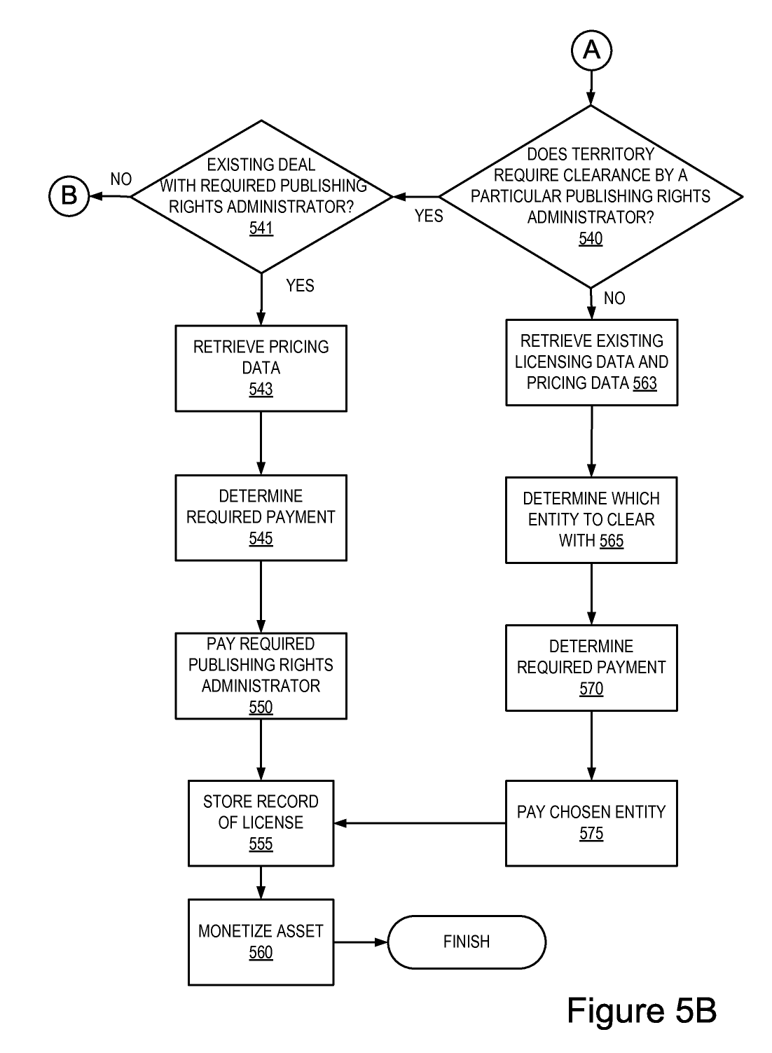

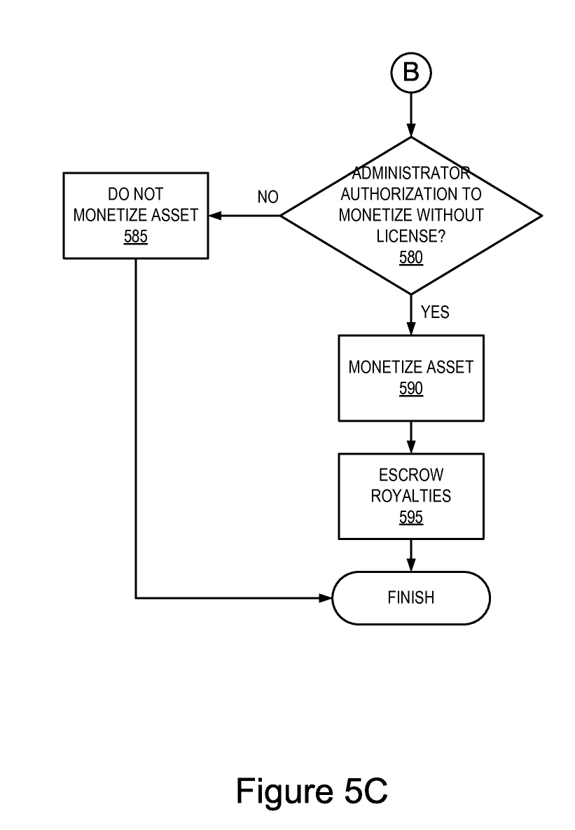

FIGS. 5A-5C are flow diagrams depicting a method 500 for clearing granular rights according to another embodiment. Turning to FIG. 5A, the communication module 201 receives 505 a description of an asset from the service provider 199. The communication module 201 also receives 510 a description of a service associated with the asset from the service provider 199. Additionally, the communication module 201 receives 515 a description of a territory in which the service is provided from the service provider 199. The communication module 201 sends the description of the asset, the description of the service and the description of the territory to the territorial requirements engine 203. The territorial requirements engine 203 determines 520 one or more territorial requirements for providing the service in the territory. The territorial requirements engine 203 sends the one or more territorial requirements to the existing license module 205 and the determination module 207.

The existing license module 205 determines one or more required rights based on the one or more territorial requirements determined in step 520. In one embodiment, the existing license module 205 determines a bundle of required rights based at least in part on the territorial requirements and the clearance module 195 performs steps 523-580 (except the monetization steps 535 and 560) for each required right before determining whether to monetize the asset or not.

At step 523, the existing license module 205 determines 523 whether there are existing licenses for the asset in the license data 330. If there is at least one existing license for the asset, the method 500 moves to step 525. Otherwise, the existing license module 203 determines that the required right is a missing right and the method 500 moves to step 540.

At step 525, the existing license module 205 retrieves license data 330 describing the existing licenses for the asset from the rules database 196.

At step 530, the existing license module 205 determines whether any of the existing licenses: (1) are licenses for the required right; and (2) meet the territorial requirements. An existing license for the required right does not meet the territorial requirements, for example, if the territorial requirements requires the license to be obtained from an entity such as a publishing rights administrator 176 and the existing licenses was obtained from a different entity. Thus, at step 530 the existing license module 205 determines whether an existing license for a required right was obtained from an entity specified by one or more of the territorial rules 310. This is an example of determining whether an existing license meets the territorial requirements; persons skilled in the art will recognize that other examples are possible. If one of the existing licenses is a license for the required right and meets the territorial requirements, the method 500 moves to step 535. Otherwise, the existing license module 205 determines that the missing right must be licensed from a licensor and the method 500 moves to step 540. At step 535, the service provider 199 monetizes the asset by providing the service to users in the territory and the method 500 ends.

Referring to FIG. 5B (on the right-hand side of the sheet), the determination module 207 determines 540 whether the territory rules 310 require the missing right to be licensed from a particular publishing rights administrator 176. In one embodiment, this step includes determining the identity of the publishing rights administrator 176 required by the applicable territory rule 310. If the territory requires the missing right be licensed from a particular publishing rights administrator 176, the method 500 moves to step 541. Otherwise, the method 500 moves to step 563.

At step 541, the determination module 207 determines whether there is an existing licensing agreement with the publishing rights administrator 176 required by the territory requirements. If there is an existing licensing agreement, the method 500 moves to step 543. Otherwise, the method 500 moves to step 580 (described below with reference to FIG. 5C). If there is an existing licensing agreement, in one embodiment the determination module 207 retrieves information about the existing licensing agreement from the license data 330 in the rules database 196 and sends the information to the payment module 211, while in other embodiments the determination module 207 sends an identifier of the existing licensing agreement to the payment module 211. The payment module 211 then takes steps to pay for a license for the missing right.

Turning to step 543, the payment module 211 receives information describing the existing licensing agreement or the identifier of the existing licensing agreement from the determination module 207 and retrieves pricing data for the existing licensing agreement from the pricing data 320 stored in the rules database 196. The payment module 211 determines 545 a required payment to the publishing rights administrator 176 for purchasing a license for the missing right in the territory based at least in part on the existing licensing agreement and the pricing data. In one embodiment, the payment module 211 receives input from an administrator of the payment module 211 and the payment module 211 determines a required payment at step 545 based at least in part on this input.

At step 550, the payment module 211 pays the publishing rights administrator 176 based on the payment determined at step 545. The payment module 211 stores 555 a record of the purchased license in the license data 330 in the rules database 196. The service provider 199 monetizes 560 the asset by providing the service to users in the territory and the method 500 ends.

Turning to step 563 (depicted under step 540 in FIG. 5B), the determination module 207 retrieves a portion of the license data 330 describing existing licensing agreements with the one or more entities from the license data 330 and pricing data 320 from the rules database 196. The determination module 207 determines 565 which entity to license the missing right from based on the licensing data and the pricing data retrieved at step 563. In one embodiment, the determination module 207 receives an input from an administrator of the asset hosting site 100, the service provider 199 or the payment module 211 and determines 565 which entity to license the missing right from based at least in part on this input. In one embodiment, the entity determined at step 565 is a preferred licensor and is selected based at least in part on one or more of the criteria described above for determining a preferred licensor. The payment module 211 determines 570 a required payment for purchasing a license for the missing right in the territory from the chosen entity and pays 575 the chosen entity. After paying the chosen entity, the method 500 moves to step 555.

Referring to FIG. 5C, the determination module 207 determines 580 whether an administrator of the service provider 199 has provided an input authorizing monetization of the asset without a license for the missing right in the territory. If authorization is provided, the method 500 moves to step 590. Otherwise, the method 500 moves to step 585.

At step 585, the service provider 199 does not monetize the asset and the method 500 ends. At step 590, the method 500 monetizes the asset by providing the service to users in the territory. At step 595, the payment module 211 escrows a payment for the license for the missing right and the method 500 ends.

FIG. 6 is flow diagram of a method 600 for updating territorial rules stored in the rules database 196 according to one embodiment. The communication module 201 receives 605 updates for territorial rules from an administrator of the asset hosting site 100 and sends the updates to the update module 209. The update module 209 identifies one or more existing territorial rules to be updated from the updates and retrieves 610 the one or more existing territorial rules from the territorial rules 310 in the rules database 196. The update module 209 modifies 615 the existing territorial rules based on the updates and stores 620 the modified territorial rules in the territorial rules 310 of the rules database 196.

The foregoing description of the embodiments has been presented for the purposes of illustration and description. It is not intended to be exhaustive or to limit the specification to the precise form disclosed. Many modifications and variations are possible in light of the above teaching. It is intended that the scope of the embodiments be limited not by this detailed description, but rather by the claims of this application. As will be understood by those familiar with the art, the examples may be embodied in other specific forms without departing from the spirit or essential characteristics thereof. Likewise, the particular naming and division of the modules, routines, features, attributes, methodologies and other aspects are not mandatory or significant, and the mechanisms that implement the description or its features may have different names, divisions and/or formats. Furthermore, as will be apparent to one of ordinary skill in the relevant art, the modules, routines, features, attributes, methodologies and other aspects of the specification can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the specification is in no way limited to implementation in any specific programming language, or for any specific operating system or environment. Accordingly, the disclosure is intended to be illustrative, but not limiting, of the scope of the specification, which is set forth in the following claims.

What is claimed is:

1. A method for providing rights clearance, the method comprising:
receiving, from a service provider, a description of a service to be provided for an asset in a territory;
determining a territorial requirement for providing the service in the territory based at least in part on a territorial rule for the territory;
determining a missing right based at least in part on the territorial requirement for providing the service in the territory; and
determining a preferred licensor for purchasing a license for the missing right in the territory.

2. The method of claim 1, wherein determining the missing right comprises:
determining a required right from the territorial requirement, wherein the required right is a right included in the territorial requirement;
determining whether the service provider owns an existing license for the required right that meets the territorial requirement; and
responsive to determining that the service provider does not own the existing license that meets the territory requirement, determining the required right as the missing right.

3. The method of claim 2, wherein determining whether the service provider owns the existing license for the required right that meets the territorial requirement comprises:
determining that the service provider owns the existing license for the required right; and
determining that the existing license does not meet the territorial requirement because the existing license was not purchased from an entity specified by the territorial rule.

4. The method of claim 1, wherein determining the preferred licensor for purchasing the license for the missing right in the territory comprises:
determining one or more entities for purchasing the license for the missing right;
retrieving licensing data and pricing data associated with the one or more entities; and
determining one of the one or more entities as the preferred licensor based at least in part on the licensing data and the pricing data.

5. The method of claim 4, wherein the pricing data includes data describing one or more of the following:
one or more prices for purchasing the license from the one or more entities;
a flat fee for purchasing the license;
a marginal fee;
a fee per use of the license;
a fee based on revenue share;
a price for an existing licensing agreement with the one or more entities;
a negotiated rate for purchasing the license for the missing right;
a negotiated rate for purchasing licenses for multiple missing rights; and
a payment for one or more of a recoupable advance and an unmet prepayment.

6. The method of claim 4, wherein the licensing data includes data describing one or more of:
data describing one or more factors from one or more existing licensing agreements with the one or more entities; and
tax data describing tax considerations for purchasing the license from one of the one or more entities.

7. The method of claim 1, wherein determining the preferred licensor for purchasing the license for the missing right in the territory comprises:
determining that the territorial rule requires the license for the missing right to be purchased from a publishing rights administrator; and
determining that the publishing rights administrator is the preferred licensor.

8. The method of claim 1 further comprising:
determining a payment for purchasing the license from the preferred licensor; and
paying the preferred licensor based at least in part on the determined payment.

9. A system for providing rights clearance, the system comprising:
a communication module for receiving, from a service provider, a description of a service to be provided for an asset in a territory;
a territorial requirements engine communicatively coupled to the communication module, the territorial requirements engine determining a territorial requirement for providing the service in the territory based at least in part on a territorial rule for the territory;
an existing license module communicatively coupled to the territorial requirements engine, the existing license module determining a missing right based at least in part on the territorial requirement for providing the service in the territory; and
a determination module communicatively coupled to the territorial requirements engine and the existing license module, the determination module determining a preferred licensor for purchasing a license for the missing right in the territory.

10. The system of claim 9, wherein the existing license module is configured to:
determine a required right from the territorial requirement, wherein the required right is a right included in the territorial requirement;
determine whether the service provider owns an existing license for the required right that meets the territorial requirement; and
responsive to determining that the service provider does not own the existing license that meets the territory requirement, determine the required right as the missing right.

11. The system of claim 10, wherein the existing license module is further configured to:
determine that the service provider owns the existing license for the required right; and
determine that the existing license does not meet the territorial requirement because the existing license was not purchased from an entity specified by the territorial rule.

12. The system of claim 9, wherein the determination module is configured to:
determine one or more entities for purchasing the license for the missing right;
retrieve licensing data and pricing data associated with the one or more entities; and
determine one of the one or more entities as the preferred licensor based at least in part on the licensing data and the pricing data.

13. The system of claim 12, wherein the pricing data includes data describing one or more of the following:
one or more prices for purchasing the license from the one or more entities;
a flat fee for purchasing the license;
a marginal fee;
a fee per use of the license;
a fee based on revenue share;
a price for an existing licensing agreement with the one or more entities;
a negotiated rate for purchasing the license for the missing right;
a negotiated rate for purchasing licenses for multiple missing rights; and
a payment for one or more of a recoupable advance and an unmet prepayment.

14. The system of claim 12, wherein the licensing data includes data describing one or more of:
data describing one or more factors from one or more existing licensing agreements with the one or more entities; and
tax data describing tax considerations for purchasing the license from one of the one or more entities.

15. The system of claim 9, wherein the determination module is configured to:
determine that the territorial rule requires the license for the missing right to be purchased from a publishing rights administrator; and
determine that the publishing rights administrator is the preferred licensor.

16. The system of claim 9, further comprising:
a payment module communicatively coupled to the determination module, the payment module determining a payment for purchasing the license from the preferred licensor and paying the preferred licensor based at least in part on the determined payment.

17. A computer program product comprising a computer usable medium including a computer readable program, wherein the computer readable program when executed on a computer causes the computer to perform steps comprising:
receiving, from a service provider, a description of a service to be provided for an asset in a territory;
determining a territorial requirement for providing the service in the territory based at least in part on a territorial rule for the territory;
determining a missing right based at least in part on the territorial requirement for providing the service in the territory; and
determining a preferred licensor for purchasing a license for the missing right in the territory.

18. The computer program product of claim 17, wherein the computer readable program when executed causes the computer to perform steps comprising:
determining a required right from the territorial requirement, wherein the required right is a right included in the territorial requirement;
determining whether the service provider owns an existing license for the required right that meets the territorial requirement; and
responsive to determining that the service provider does not own the existing license that meets the territory requirement, determining the required right as the missing right.

19. The computer program product of claim 18, wherein the computer readable program when executed causes the computer to perform steps comprising:
determining that the service provider owns the existing license for the required right; and
determining that the existing license does not meet the territorial requirement because the existing license was not purchased from an entity specified by the territorial rule.

20. The computer program product of claim 17, wherein the computer readable program when executed causes the computer to perform steps comprising:
determining one or more entities for purchasing the license for the missing right;
retrieving licensing data and pricing data associated with the one or more entities; and
determining one of the one or more entities as the preferred licensor based at least in part on the licensing data and the pricing data.

21. The computer program product of claim 20, wherein the pricing data includes data describing one or more of the following:
one or more prices for purchasing the license from the one or more entities;
a flat fee for purchasing the license;
a marginal fee;
a fee per use of the license;
a fee based on revenue share;
a price for an existing licensing agreement with the one or more entities;
a negotiated rate for purchasing the license for the missing right;
a negotiated rate for purchasing licenses for multiple missing rights; and
a payment for one or more of a recoupable advance and an unmet prepayment.

22. The computer program product of claim 20, wherein the licensing data includes data describing one or more of:
data describing one or more factors from one or more existing licensing agreements with the one or more entities; and
tax data describing tax considerations for purchasing the license from one of the one or more entities.

23. The computer program product of claim 17, wherein the computer readable program when executed causes the computer to perform steps comprising:
determining that the territorial rule requires the license for the missing right to be purchased from a publishing rights administrator; and
determining that the publishing rights administrator is the preferred licensor.

24. The computer program product of claim 17, wherein the computer readable program when executed causes the computer to perform steps comprising:
determining a payment for purchasing the license from the preferred licensor; and
paying the preferred licensor based at least in part on the determined payment.
